(19) United States
(12) Patent Application Publication
(10) Pub. No.: US 2025/0182039 A1
(43) Pub. Date: Jun. 5, 2025

(54) PHYSICAL DISTRIBUTION MANAGEMENT DEVICE, METHOD OF CONTROLLING PHYSICAL DISTRIBUTION MANAGEMENT DEVICE, AND CONTROL PROGRAM

(71) Applicant: MISUMI Group Inc., Tokyo (JP)

(72) Inventors: Takashi BABA, Tokyo (JP); Chi ZHANG, Tokyo (JP)

(73) Assignee: MISUMI Group Inc., Tokyo (JP)

(21) Appl. No.: 18/292,675

(22) PCT Filed: Sep. 17, 2021
(86) PCT No.: PCT/JP2021/034392

§ 371 Date: Jan. 26, 2024

(51) Int. Cl. G06Q 10/0835; G06Q 10/087

(52) U.S. Cl. CPC G06Q 10/0835; G06Q 10/087

(57) ABSTRACT

A physical distribution management device manages a physical distribution system using a first storage storing a first type article to be received by a user using an article, a second storage storing a second type article to be transported to a user using the plural first storages, and a third storage storing a third type article to be transported to a user using the plural first storages corresponding to the second storages. The device has an acquisition unit acquiring a use frequency of the article, and a classification unit classifying the article corresponding to a first use frequency as the first type article, the article corresponding to a second use frequency as the second type article, and the article corresponding to a third use frequency as the third type article, based on the use frequency of the user belonging to a transport target region set for the third storage.

### CROSS-REFERENCE TO RELATED PATENT APPLICATIONS

This application is a U.S. National Phase application under 35 U.S.C. § 371 of International Patent Application No. PCT/JP2021/034392 filed on Sep. 17, 2021, the content of which is incorporated herein by reference in its entirety. The International Application was published in Japanese on Mar. 23, 2023 as International Publication No. WO 2023/042394 under PCT Article 21(2).

### FIELD OF THE INVENTION

The present invention relates to the field of distribution, and more particularly to a physical distribution management device, a method of controlling a physical distribution management device, and a control program.

### BACKGROUND OF THE INVENTION

In recent years, with rapid development of e-commerce and distribution industries, higher demands are made on distribution efficiency and warehouse management. For each company that needs to distribute articles, the locations of warehouses and the stock levels are extremely important. Unreasonable warehouse locations and stock levels can significantly reduce the operational efficiency of the supply chain, impact the revenue of the company, and result in unnecessary losses.

At present, some companies have installed their own warehouse spaces to stock articles, which causes an increase in production cost. In addition, various articles are stacked, complicated work is required for handling and replacement, and work efficiency is extremely poor. In the field of distribution, according to the current selecting of warehouse locations and current supplying method, the distribution supply chain is operated by dividing the supply region, installing warehouses in different supply regions, and substantially covering the user needs in the regions by articles stored in the respective warehouses.

Meanwhile, in a region covered by one or a plurality of warehouses, a region centered on the warehouses and a region close to a marginal region still exist. The existing supply method cannot guarantee the supply speed for the marginal region. In addition, user demands in one region are relatively complex, and the warehouse needs to store many items. In addition, different items often have certain conditions in a storage space and a storage method. Thus, the cost of the warehouse is increased, and stacking of articles of complex item types increases the safety risk of the warehouse. Therefore, in the field of distribution, there is an urgent need to provide a physical distribution system and a method capable of reducing the risk of backlog of articles and simultaneously improving the supply efficiency.

Japanese Patent Application Laid-Open No. 2019-36308 stated below discloses a storage management method for an intelligent warehouse. The storage management method is a method for managing a material necessary for product production, and includes an acquisition step of acquiring production plan data for a product and a safety coefficient of the material, and a prediction step of predicting a predicted usage quantity of the material based on the production plan data and the safety coefficient. Then, production data based on the production plan data and the predicted usage quantity are transmitted to an unmanned intelligent warehouse storage device. In addition, the production data is updated in real time according to the usage state of the material stored in the unmanned intelligent warehouse storage device.

### CITATION LIST

### Patent Literature

Patent Literature 1: Japanese Patent Application Laid-Open No. 2019-36308

### SUMMARY OF THE INVENTION

### Technical Problem

An object of the present invention is to provide a physical distribution management device, a method of controlling of a physical distribution management device, and a control program that address the technical problem described above.

### Solution to Problem

One aspect of the present invention is a physical distribution management device that manages a physical distribution system using a first storage that stores a first type article to be received by a user who uses an article, a second storage that stores a second type article to be transported to a user who uses each of a plurality of the first storages, and a third storage that stores a third type article to be transported to a user who uses each of the plurality of the first storages corresponding to respective ones of a plurality of the second storages, the physical distribution management device comprising: an acquisition unit acquiring a use frequency of the article of each user; and a classification unit classifying the article corresponding to a first use frequency as the first type article, classifying the article corresponding to a second use frequency lower than the first use frequency as the second type article, and classifying the article corresponding to a third use frequency lower than the second use frequency as the third type article, based on the use frequency of each of a plurality of users belonging to a transport target region set for the third storage.

Another one aspect of the present invention is a method of controlling a physical distribution management device that manages a physical distribution system using a first storage that stores a first type article to be received by a user who uses an article, a second storage that stores a second type article to be transported to a user who uses each of a plurality of the first storages, and a third storage that stores a third type article to be transported to a user who uses each of the plurality of the first storages corresponding to respective ones of a plurality of the second storages, the method comprising: acquiring a use frequency of the article of each user; and classifying the article corresponding to a first use frequency as the first type article, classifying the article corresponding to a second use frequency lower than the first use frequency as the second type article, and classifying the article corresponding to a third use frequency lower than the second use frequency as the third type article, based on the use frequency of each of a plurality of users belonging to a transport target region set for the third storage.

Still another aspect of the present invention is a control program of a physical distribution management device that manages a physical distribution system using a first storage that stores a first type article to be received by a user who uses an article, a second storage that stores a second type article to be transported to a user who uses each of a plurality of the first storages, and a third storage that stores a third type article to be transported to a user who uses each of the plurality of the first storages corresponding to respective ones of a plurality of the second storages, the control program causing a processor of the physical distribution management device to function as: an acquisition unit acquiring a use frequency of the article of each user; and a classification unit classifying the article corresponding to a first use frequency as the first type article, classifying the article corresponding to a second use frequency lower than the first use frequency as the second type article, and classifying the article corresponding to a third use frequency lower than the second use frequency as the third type article, based on the use frequency of each of a plurality of users belonging to a transport target region set for the third storage.

### Advantageous Effects of Invention

According to the present invention, articles classified in descending order of use frequency are stored in a plurality of storages, and the articles are supplied to a user while covering the plurality of storages, so that it is possible to address the disadvantages of the conventional technique that articles of a low use frequency are accumulated and supply efficiency is poor.

### BRIEF DESCRIPTION OF THE DRAWINGS

FIG. 1 is a distribution diagram of storages of a physical distribution system provided in the present embodiment.

FIG. 2 is a schematic diagram of transport paths and a signal link for one of the first storages in the present embodiment.

FIG. 3 is a system schematic diagram of the physical distribution system for a single storage in the present embodiment.

FIG. 4 is a schematic diagram illustrating a configuration of an automatic locker according to the present embodiment.

FIG. 5 is a schematic diagram of a vendor database according to the embodiment of the present invention.

FIG. 6 is a schematic diagram of article databases of different types in the vendor database provided in the embodiment of the present invention.

FIG. 7 is a schematic diagram of a user authority database provided by the present embodiment.

FIG. 8 is a schematic diagram illustrating a flow of an article processing method provided in the embodiment of the present invention.

FIG. 9 is a schematic diagram of supply paths provided in an embodiment of the present invention.

FIG. 10 is a schematic diagram of further supply paths provided in the present embodiment.

### DETAILED DESCRIPTION OF THE INVENTION

Specific embodiments of the present invention are described in detail below. It should be noted that the following embodiments are intended for those skilled in the art to further understand the present invention, and do not limit the present invention in any way. In addition, those skilled in the art can modify or improve the embodiments without departing from the concept of the present invention. All the modified and improved embodiments fall in the protection scope of the present invention.

In the field of distribution, in the current stocking method, a stocking region is sectioned, and warehouses are installed in different stocking regions. The articles stored in the warehouses can basically meet the user needs in the stocking regions. This realizes a supply chain operation of distribution. In a stocking region covered by one or a plurality of warehouses, a region centered on the warehouses and a marginal region close to an edge of the stocking region exist. Therefore, the conventional stocking method cannot guarantee the stocking speed in the marginal region.

In addition, user needs in one stocking region are relatively complex, and a warehouse needs to store many articles. An article of a less use frequency has a relatively high risk to be accumulated in a warehouse. Furthermore, since the number of types of articles in the warehouse is relatively large, some problems such as a problem that a stocking quantity of articles is insufficient, or a problem that articles cannot be collected may be caused. In addition, each of different articles often has a predetermined condition for a storage space and a storage method. Thus, the cost of the warehouse is increased, and stacking of complex article types increases the safety risk of the warehouse.

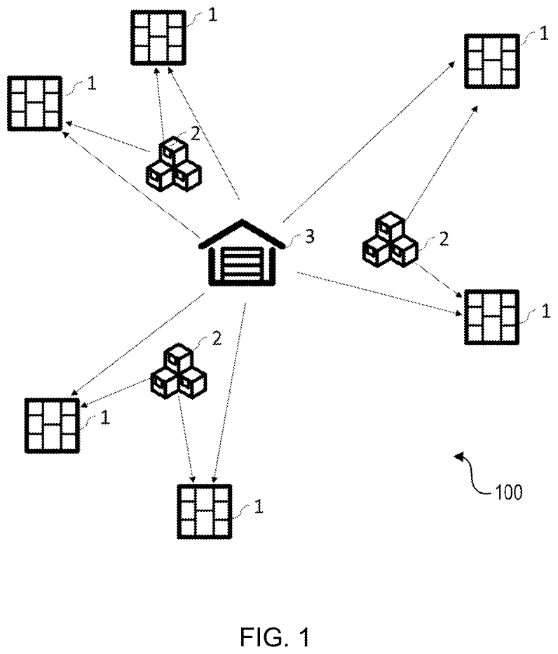

In the present embodiment, a physical distribution system 100 is provided. FIG. 1 is a distribution diagram of storages of the physical distribution system 100 provided in the present embodiment. Referring to FIG. 1, the physical distribution system 100 includes first storages 1, second storages 2, and a third storage 3. In the following description, transportation of articles to users who use the first storages 1 has various aspects. For example, the articles may be transported to a location of a user to which a plurality of users using the articles belong, e.g., a location of a company user. In this case, the company user is a user who uses one of the first storages 1. The articles may also be transported to a location of a factory user belonging to the company user. In this case, the factory user is a user who uses the first storage 1. The articles may be transported to the place where the first storage 1 is installed, and the first storage 1 may be replenished with the transported articles.

The first storage 1 stores a first type article to be received by a user who uses the article. The first storage 1 is installed in a region where a user is located or near the region, covers a small region, and has a small storage space. For example, in a case where the user is in a factory, the first storage 1 is installed in or near the factory. As an example, the first storage 1 is a vending machine (hereinafter, also referred to as “vendor”) or an automatic locker from which a user takes out an article by himself/herself. Note that the first storage 1 is a place where an article is directly supplied to the user, and may be a box, a storeroom, or a small warehouse where the user directly receives the article.

At least a part of the space of the first storage 1 stores a first type article corresponding to a first use frequency. The first use frequency is relatively high. For example, consumables such as gloves or masks are stored in the space. When the user is in urgent need of the first type article, the user can obtain it directly from the first storage 1 in or near the factory. This significantly improves the transportation efficiency of the first type article.

The second storages 2 store second type articles to be transported to a user who uses each of the plurality of first storage 1. That is, the second storages 2 store the second type articles to be transported to one or a plurality of users who use each of the first storages 1. Specifically, each of the second storages 2 is a sub-warehouse, and is, for example, a warehouse covering a medium-scale region or a warehouse having a medium storage space. The plurality of first storages 1 is installed in a transport target region covered by each of the plurality of second storages 2. Note that the second storage 2 may be a middle-sized storage device that automatically carries out articles, or may be a factory of a production manufacturer or a warehouse of a seller. A plurality of the first storages 1 is installed in a medium-scale region. As an example, the transport distances between the second storage 2 and the users are distances over which transportation is possible within 4 hours.

At least a part of the space of the second storage 2 stores a second type article corresponding to a second use frequency lower than the first use frequency. The second use frequency is a medium use frequency. For example, the second type article is an article that a user strongly needs to use when a demand by the user occurs, but is used relatively less frequently than the first type article. Examples of the second type article include, a wrench, a screw driver, and a winding. By arranging such second type articles in the sub-warehouses, the distribution speed of the second type articles can be secured, and the transportation cost of the second type articles can be reduced.

The third storage 3 stores third type articles to be transported to a user who uses each of the plurality of first storages 1 corresponding to respective ones of the plurality of second storages 2. That is, the third storage 3 stores the third type articles to be transported to one or a plurality of users who use each of the first storages 1. Specifically, the third storage 3 is a main warehouse, and is a warehouse covering a relatively large region or a warehouse having a large storage space. In the transport target region covered by the third storage 3, the plurality of second storage 2 is provided. Note that the third storage 3 may be a large storage device that automatically carries out articles, or may be a factory of a production manufacturer or a warehouse of a seller. The cover region covered by the third storage 3 includes all the cover regions covered by the plurality of second storage 2 corresponding to the third storage 3. The transport distance between the third storage 3 and the user is, in most cases, longer than the distance between the second storage 2 and the user. The distance is a distance which is used for a relatively long distance transportation/distribution, and over which transportation is possible within 24 hours, for example.

The third storage 3 stores third type articles corresponding to a third use frequency lower than at least the second use frequency. The third type article is an article that is usually not suddenly required by a user and is less frequently used than the second type article, such as a foot ring or a coupling. However, the third type articles include articles that are not frequently used depending on types, some types of which are frequently used but other types of which are not frequently used. For example, bearings are frequently used as a whole, but there are many types of bearings. As such, the actual use frequency of bearings of each particular type is not high, and a user usually does not need to receive this article quickly. Therefore, such article can be stored in the third storage 3 as a third type article.

The use frequency of an article by a user is determined according to the number of used articles, the number of consumed articles, the number of purchased articles or the like within a certain period of time (for example, four weeks). A first type article group of a high use frequency is supplied or sold at the first storages 1. Then, a second type article group of a medium use frequency is transported from the second storages 2 to users who use the first storages 1. In addition, the third type article group of a low use frequency is transported from the third storage 3 to the users who use the first storages 1.

The classification of articles is appropriately optimized according to the number of used articles, the number of consumed articles, the number of purchased articles or the like. As an example, in the region covered by the second storage 2, articles, quantities of which are set by considering the storable quantity of the first storages 1, are classified as the first type articles in descending order of use frequency and stored in the first storages 1. As a result, the articles stored in the first storages 1 can be made common in the region covered by the second storage 2. In the region covered by the third storage 3, other articles with the medium use frequency are classified as the second type articles and stored in the second storages 2. As a result, the articles stored in the second storages 2 can be made common in the region covered by the third storage 3. Then, the remaining articles with the low use frequency are classified as the third type articles and stored in the third storage 3.

In addition, the classification criteria of the first type article, the second type article, and the third type article may vary depending on users. For example, for a user in a factory, articles usually used for machining such as gloves or protective clothing may be included in the first type articles. However, for a user in a design company, articles such as gloves or protective clothing are not regularly used and are not included in the first type articles. On the other hand, some surveying tools or drafting tools are likely to be included in the first type articles for a user in a design company.

In the present embodiment, the classification criteria of the first type article, the second type article, and the third type article can be determined by agreement between a supplier of articles and a user. For example, a contract may be concluded between a user and a supplier, and the classification may be stored as data in a database of the physical distribution system 100. As a result, a more customized service can be provided to the user. In addition, the first type articles, the second type articles, and the third type articles may include the same article.

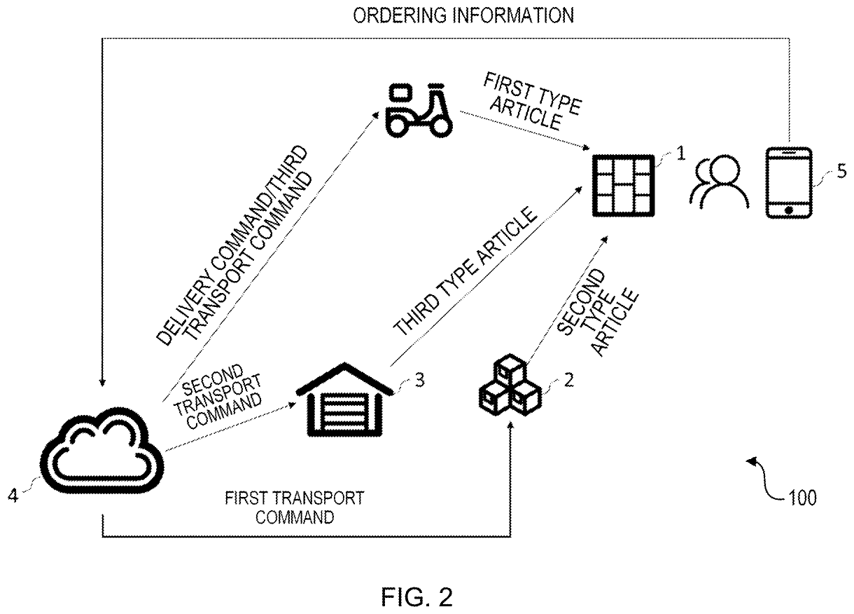

FIG. 2 is a schematic diagram of transport paths and a signal link for one of the first storage 1 in the present embodiment. Referring to FIG. 2, the physical distribution system 100 provided by the present embodiment further includes a server 4 as an example of a distribution monitoring device, and an ordering device 5. The ordering device 5 can be used to receive an order from a user, and may be a mobile device in which a client application is installed, or may be a terminal device installed in the first storage 1. Alternatively, the ordering device 5 may be an external device not included in the physical distribution system 100.

The method of receiving an order placed by a user may be a method in which the user directly places an order on the client application or the terminal device and transmits the ordering information that has been processed to the server 4. Alternatively, the method may be a method in which the user concludes a contract with a service provider for ordering articles, and the service provider transmits ordering information to the server 4. For example, the service provider inputs the content of an article that the user desires to order to the terminal device, and generates an account corresponding to the user. Then, the ordering information is generated under the account corresponding to the user, and the ordering information obtained by the generation processing is transmitted from the terminal device of the service provider to the server 4.

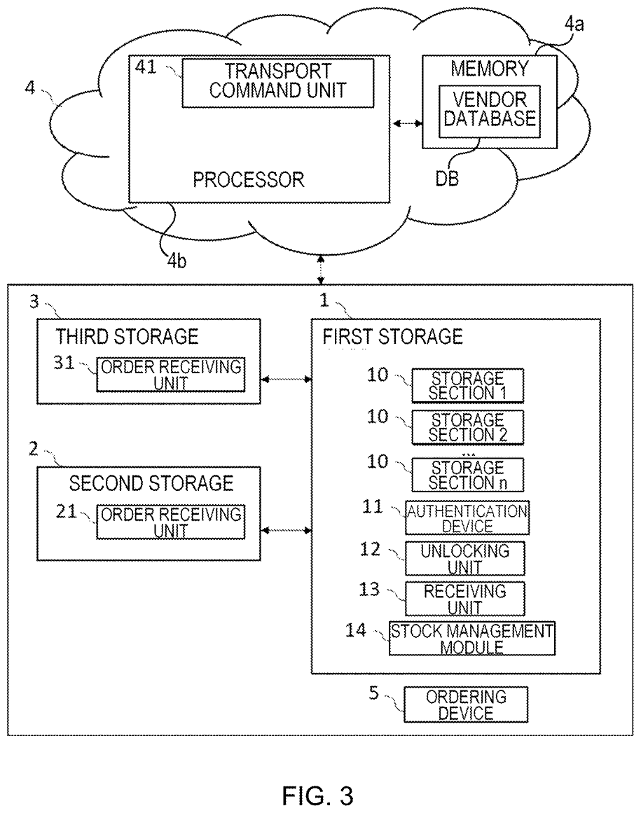

FIG. 3 is a system schematic diagram of the physical distribution system 100 for one of the first storages 1 in the present embodiment. Referring to FIG. 3, the server 4 according to the present embodiment includes a memory 4a and a processor 4b. The memory 4a stores commands or data for performing various types of processing of the present embodiment. Then, the commands or the data are read by the processor 4b. The data includes a vendor database DB.

The processor 4b includes a transport command unit 41 as a logical device. The processor 4b functions as an acquisition unit that acquires a use frequency of an article of each user and a classification unit that classifies the article as the first type article, the second type article, or the third type article. Then, the processor 4b as the classification unit performs the classification processing of classifying the article corresponding to the first use frequency as the first type article based on the use frequencies of the plurality of users belonging to the transport target region set for the third storage 3. In the classification processing, the processor 4b classifies an article corresponding to the second use frequency lower than the first use frequency as the second type article, and classifies an article corresponding to the third use frequency lower than the second use frequency as the third type article.

The processor 4b performs the classification processing periodically (for example, every quarter). In addition, the processor 4b may perform the classification processing in a case where a new user is set, in a case where a new article is set, or in a case where the first storage, the second storage, or the third storage is newly set. Furthermore, the processor 4b may perform the classification processing in response to an operation by a manager of the server 4 or in response to a request from a user. In addition, the processor 4b may perform the classification processing when the consumption quantity of the first type articles, the second type articles, or the third type articles reaches a predetermined quantity. Note that the processor 4b may simultaneously perform the classification processing on the first type article, the second type article, and the third type article, or may perform the classification processing for each article.

Furthermore, the processor 4b as the classification unit classifies the article as the first type article, the second type article, or the third type article for each user. That is, the articles classified as the first type article, the second type article, and the third type article may be different depending on the user. For example, gloves classified as the first type article for a user in a factory may be classified as the third type article for a user in a design company.

The first storage 1 stores the first type article classified for each user. Then, the second storage 2 stores all the second type articles classified for each of the plurality of users corresponding to the plurality of first storages 1 in the transport target region covered by the second storage 2. In addition, the third storage 3 stores all the third type articles classified for each of the plurality of users corresponding to the plurality of first storages 1 in the transport target region covered by the third storage 3. For example, the third storage 3 stores a surveying tool classified as the third type article for a user in a factory and gloves classified as the third type article for a user in a design company.

As an example, the transport command unit 41 sends a transport command instructing a supplier of the first type article to transport the first type article based on the information about the classified first type article. For example, the transport command unit 41 issues an initial transport command for causing transportation of the first type article for the first time to a user who uses the first storage 1. The supplier transports the first type article, and the first type article is stored in the first storage 1.

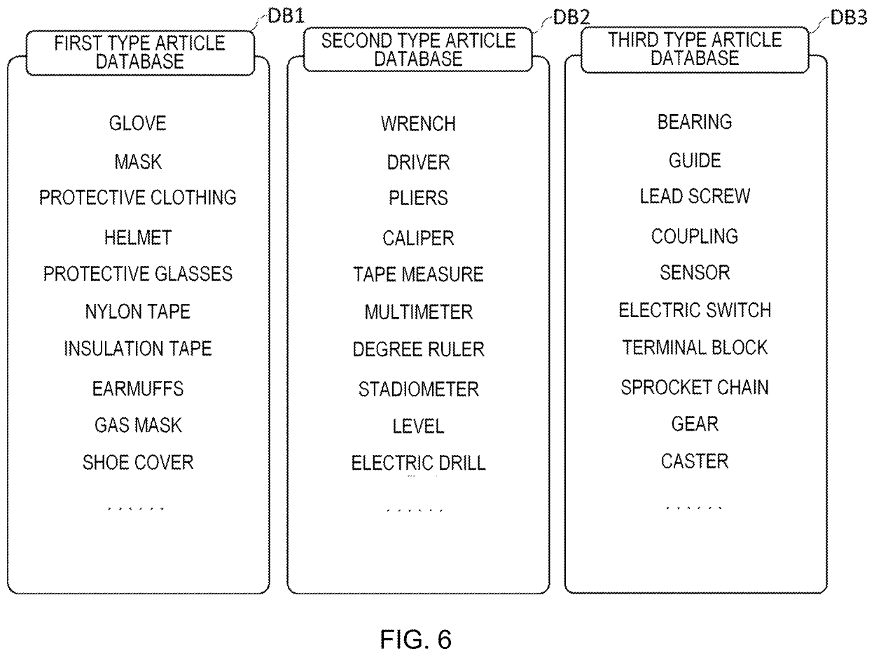

The transport command unit 41 may also send a transport command for the second type article to the supplier of the second type article based on the information about the classified second type article. The supplier transports the second type article, and the second type article is stored in the second storage 2. In addition, the transport command unit 41 may send the information about the classified second type article and the transport command to a manager or a management system that manages the second storage 2. Then, the manager or the management system stocks the second type article based on the information about the second type article, and the second type article is stored in the second storage 2. In addition, the transport command unit 41 may send the transport command to the manager or the management system that manages the second storage 2. Then, the manager or the management system acquires information of the second type article from a database (for example, FIG. 6). Furthermore, the manager or the management system stocks the second type article based on the acquired information, and the second type article is stored in the second storage 2.

The transport command unit 41 may also send a transport command for the third type article to the supplier of the third type article based on the information about the classified third type article. The supplier transports the third type article, and the third type article is stored in the third storage 3. In addition, the transport command unit 41 may send the information about the classified third type article and the transport command to a manager or a management system that manages the third storage 3. Then, the manager or the management system stocks the third type article based on the information of the third type article, and the third type article is stored in the third storage 3. In addition, the transport command unit 41 may send the transport command to the manager or the management system that manages the third storage 3. Then, the manager or the management system acquires information about the third type article from the database (for example, FIG. 6). Furthermore, the manager or the management system stocks the third type article based on the acquired information, and the third type article is stored in the third storage 3.

The processor 4b as the acquisition unit acquires ordering information from the ordering device 5 of the physical distribution system 100. Furthermore, the processor 4b acquires article delivery information from the first storage 1.

The processor 4b also functions as a transport command unit that transmits a first transport command to the second storage 2 or that transmits a second transport command to the third storage 3, in response to acquisition of the ordering information. Here, the first transport command includes information for specifying the second type article to be transported from the second storage 2 to a user who uses the first storage 1. The second transport command includes information for specifying a third type article to be transported from the third storage 3 to a user who uses the first storage 1. Furthermore, the processor 4b as the transport command unit transmits the first transport command or the second transport command when the processor 4b does not acquire a subsequent ordering information associated with the first storage 1 within a certain period of time after acquiring the ordering information.

Furthermore, the processor 4b as the transport command unit transmits the first transport command or the second transport command in response to acquisition of the transport request. In addition, the processor 4b adds an article associated with the ordering information to a purchase list. Then, the processor 4b transmits the first transport command or the second transport command when the total amount of money of articles added to the purchase list becomes more than a preset amount of money threshold. Furthermore, the processor 4b predicts which article will belong to the first type article within a certain period of time based on the current transaction record of the first storage 1 or the current log information of the user corresponding to the first storage 1. Then, the processor 4b classifies the first type article based on the prediction result.

In addition, the processor 4b also functions as an update unit that updates the article data when acquiring the article delivery information from the first storage 1. The article data indicates the quantity of articles stored in the first storage 1, and is stored in the memory 4a.

In addition, the memory 4a stores a control program for the physical distribution management device. The processor 4b executes the control program for the physical distribution management device, thereby the processor 4b functions as the acquisition unit, the classification unit, the transport command unit, and the update unit. As an example, the processor 4b includes the transport command unit 41. The transport command unit 41 functions as transport command means.

The transport command unit 41 issues an initial transport command to transport the first type article to the first storage 1 for the first time. Further, the transport command unit 41 issues a transport command to transport of the first type article to a user who uses the first storage 1. The server 4 is communicably connected to the first storage 1 (for example, a vendor) and the ordering device 5. The transport command unit 41 can receive ordering information from the ordering device 5. The ordering device 5 can receive ordering information from the user and transmit the ordering information to the transport command unit 41. Then, the transport command unit 41 can perform division of the ordering information, calculation, distribution, or other appropriate processing based on the ordering information.

The order processable by the server 4 provided by the present embodiment may be a pre-order or a temporary order. The user generates a reservation document, and thereby the user can reserve an article that may be used within a certain period of time thereafter. After generating the reservation document, a transport person transports predetermined types and quantities of articles listed in the reservation document to a predetermined place at a predetermined time, and periodically repeats the transportation.

In a case where a temporary article demand by the user occurs, a temporary slip can be generated, and the transport person transports the specified article to the specified place within a predetermined time. The temporary slip relates to demand that occurs temporarily as compared with the reservation document. Therefore, the transportation speed by the temporary slip is an important index for performance evaluation of the physical distribution system 100.

The transport command unit 41 provided by the present embodiment can achieve both the processing for the pre-order and the processing for the temporary order. The transport command unit 41 can especially increase the overall transportation speed for the temporary order. Taking a temporary order as an example, the temporary order by a user may simultaneously include the first type article, the second type article, and the third type article. In addition, the temporary order may include only the first type article, or only the second type article, or any other similar situations can be assumed.

In a case where the first type article, the second type article, and the third type article are simultaneously included in a temporary slip created by a user, the transport command unit 41 can determine the transport destination of the articles according to the article types. Then, the transport command unit 41 sends a transport command to the storage corresponding to the transport destination. Specifically, the temporary order is divided into a plurality of sub orders. For example, the plurality of sub orders includes at least a first sub order, a second sub order, and a third sub order. The first sub order is a sub order of the first type article obtained by dividing the original order. Then, based on the first sub order, the server 4 issues an initial transport command (or a third transport command) for causing a supplier (for example, a carrier, a production manufacturer, a seller, or a distributor) of the first type article to transport the first type article to a user who uses the first storage 1. Note that the first type article may also be stored in the second storage 2, and a management company of the second storage 2 may play a role of a supplier of the first type article. Similarly, the first type articles may also be stored in the third storage 3, and the management company of the third storage 3 may play the role of the supplier of the first type article.

The second sub order is a sub order of the second type article obtained by dividing the original order. According to the second sub order, the transport command unit 41 sends the first transport command, and the first transport command includes a transport instruction for transporting the second type article from the second storage 2 to a user who uses the first storage 1. That is, when a certain quantity of the second type articles is included in the original order, the transport command unit 41 can transmit the first transport command to the second storage 2 so that the quantity of the second type articles corresponding to the ordered quantity is transported from the second storage 2 to a user who uses the first storage 1.

The third sub order is a sub order of the third type article obtained by dividing the original order. Similarly, when a certain quantity of the third type articles is included in the original order placed by the user, the transport command unit 41 can transmit the second transport command to the third storage 3 so that the quantity of third type articles corresponding to the ordered quantity is transported from the third storage 3 to the user who uses the first storage 1.

In a case where only the first type article is included in the temporary order generated by the user, if the first type article is stored in the second storage 2 or the third storage 3, the first type article can be delivered from the second storage 2 or the third storage 3 to the user who uses the first storage 1. Alternatively, the order may be directly placed to a manufacturer or a seller of the first type article, and the manufacturer or the seller of the first type article may take on the work of transportation to a user who uses the first storage 1.

When the temporary order from the user includes only the second type article or the third type article, the transport command unit 41 selectively transmits the transport command. Specifically, when only the second type article is included in the temporary order, the first transport command is generated from information such as the type and quantity of the second type article(s) in the temporary order. Then, the first transport command is sent to the second storage 2, and the computer device or the person in charge of the second storage 2 arranges transportation of the second type article(s). When only the third type article is included in the temporary order, transportation may be arranged in the same manner as in the above case.

In the present embodiment, order receiving units 21 and 31 communicating with the transport command unit 41 arrange transportation after receiving the ordering information by the user. Then, the corresponding article is transported by the transporter and stored in the first storage 1 or directly delivered to the user. Furthermore, in the present embodiment, the first storage 1 is a vending machine installed near a place where the user is, and is installed, for example, on the site of the factory or near the factory.

Alternatively, the first storage 1 is an automatic locker from which the receiver takes out the part by himself/herself. Then, the transport service provider places the article ordered by the user in one of a plurality of storage sections 10 of the automatic locker. The transport service provider then locks the storage section 10. The user is then authenticated in a manner such as a dynamic password, identity authentication (for example, image identification or card identification), or wireless communication. After being authenticated, the user unlocks the corresponding storage section 10 using an unlocking unit 12, and takes out the article in the corresponding storage section by himself/herself. By installing the automatic locker and causing the automatic locker to cooperate with the physical distribution system 100 introduced in the present embodiment, it is possible to reduce personnel for purchasing that would be individually arranged. Furthermore, it is possible to satisfy the article purchasing needs of different users without requiring personnel for purchasing, and to reduce the workload at stages of, for example, purchasing and payment.

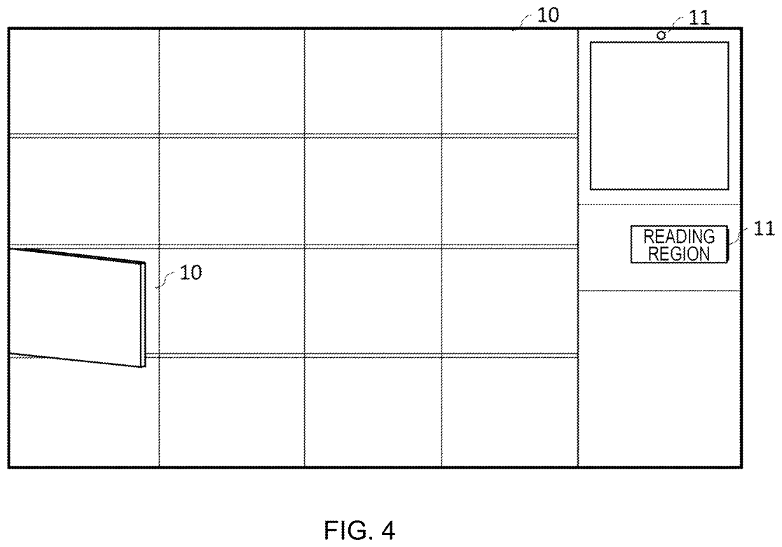

FIG. 4 is a schematic structural diagram of the automatic locker provided in the present embodiment. Referring to FIGS. 3 and 4, the automatic locker includes an authentication device 11 and a plurality of storage sections 10. The authentication device 11 includes an IC card reading device and a camera, and can authenticate the identity of a user by a card reading recognition method or an image recognition method to determine the authority of a sub user. Different storage sections 10 store different types or different quantities of first type articles. However, the same type and the same quantity of first type articles may be stored in the different storage sections 10. In some implementations, some of the storage sections 10 may be used for temporary storage of the second type article or the third type article.

In a case where a main user who uses the first storage 1 is a company user, the company user can make an account for at least some of employees (sub users) who use the article. Each account has a corresponding authority, and the account and the corresponding authority are recorded in a user authority database DB4 of the server 4. Of course, the account and the corresponding authority may be stored in the automatic locker. Accounts with different authorities have receiving authorities of different types or quantities of the first type articles. For example, an account with a higher authority may receive a larger number of types or a larger quantity of the first type articles. On the other hand, an account with a lower authority may receive a relatively small number of types or a small quantity of articles.

By setting different authorities, the physical distribution system 100 according to the present embodiment can open a locker door of the corresponding storage section 10 according to the authority of a sub user recognized by the authentication device 11. In particular, the storage section 10 in which the rocker door is opened may be a storage section 10 in which a corresponding type and quantity of first type articles are stored. For example, a department or an employee having a normal authentication may receive 8 boxes of masks every week, and a department or an employee having a higher authentication may receive 10 boxes of masks every week. In this case, 8 boxes of masks corresponding to the normal authority are placed in one storage section 10 as one set, and 10 boxes of the masks corresponding to the high authority are placed in one storage section 10 as one set.

When a department or an employee having a normal authentication needs to receive masks, the storage section 10 containing 8 boxes of masks is opened. When a department or an employee having a higher authentication needs to receive masks, the storage section 10 containing 10 boxes of masks is opened. As described above, each sub user can acquire a reasonable quantity of the first type articles according to the preset rule, and the safety of the acquisition and the reasonability of distribution of the first type articles can be improved.

In addition, in some embodiments, in order to provide easy handling for an employee who is not skilled in using a mobile terminal, the ordering device 5 that allows a sub user to place an order directly on the ordering device 5 incorporated in the mobile terminal may be incorporated in the mobile terminal.

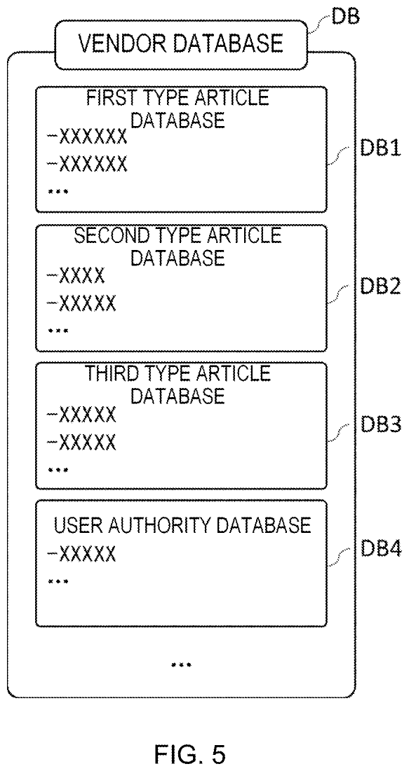

In the physical distribution system 100 of the present embodiment, the server 4 stores the vendor database DB that is a database provided for each vending machine. Referring to FIG. 5, the server 4 includes a first type article database DB1, a second type article database DB2, a third type article database DB3, a user authority database DB4, and other databases together with the vendor database DB corresponding to each vending machine.

Referring to FIG. 6, the first type article database DB1 stores at least a type list of first type articles including all types of articles classified as the first type articles. Similarly, the second type article database DB2 includes the type list of all the types of articles classified as the second type articles. In addition, the third type article database DB3 includes the type list of all the types of articles classified as the third type articles. The first type article database DB1, the second type article database DB2, and the third type article database DB3 are used to search which type of article the article belongs to, based on the type of article.

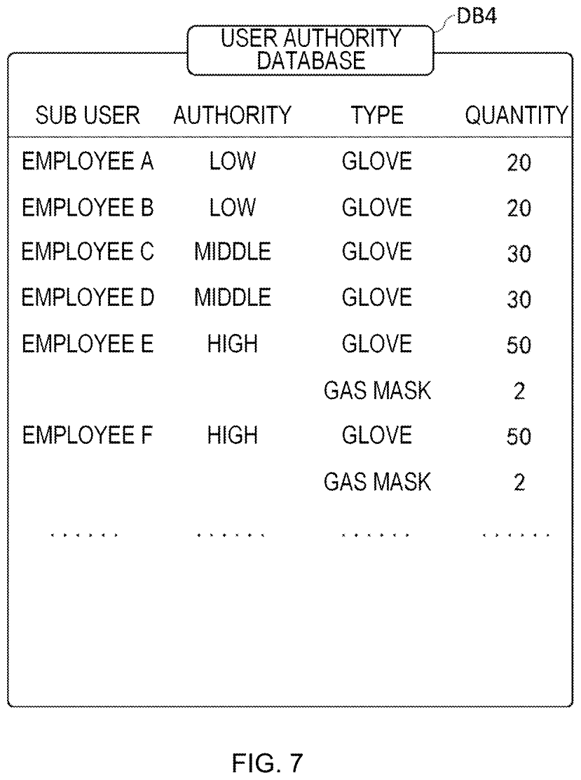

Referring to FIG. 7, the user authority database DB4 is set for the self-taking out function of the vending machine. Specifically, the user authority database DB4 includes information of a plurality of sub users of the user and authority setting corresponding to each sub user. The setting of each authority can be made by a method of setting the type, the quantity, or the total amount of money of usable articles. The sub user with each authority can receive the articles until the type of articles, the quantity of articles taken out, or the total amount of money, that can be taken out within a specified period of time such as within one month, reaches the upper limit. In some embodiments, it is also possible to record the total quantity of articles for each type of article consumed by each sub user in the user authority database DB4, and transmit the total quantity to the user at the time of periodic payment to share the information with the user.

In the present embodiment, the vending machine includes a stock management module 14 (FIG. 3). The stock management module 14 is used to monitor the stock quantity of the first type articles of the vending machine and transmits a transport request when the stock quantity is less than a threshold. According to this preferred technique, when the stock quantity of the first type articles decreases to a threshold or less, the first type articles can be automatically transported, the stock quantity of the first type articles can be always maintained at a reasonable level or more, and it can be guaranteed that the supply of the first type articles is sufficient.

In another embodiment, the stock management module 14 may also periodically transmit the transportation request based on the ordering information. For example, a provider of the transport service can conclude a contract with a user in advance to determine information such as a time interval of transportation, the number of times of transportation, an article type in each transportation, and a transportation quantity. Thereafter, the service provider can periodically transport the article based on the rule determined in advance. Then, the service provider can arrange and provide periodic payment and transport services more easily.

In addition, an embodiment of the present invention provides an article processing method for determining an aspect of storage and distribution of an article using command calculation of a calculation device. This article processing method is performed by the server 4 arranged in the cloud, a terminal device of the user, or a computing device used by a vending machine installed by the user. The article processing method provided by the present embodiment adjusts storage places and transportation methods of different types of articles by executing a readable command of a calculation device. Then, by using warehouses of different cover ranges, it is possible to store articles with different use frequencies, improve transportation efficiency, and reduce a safety risk of the warehouses.

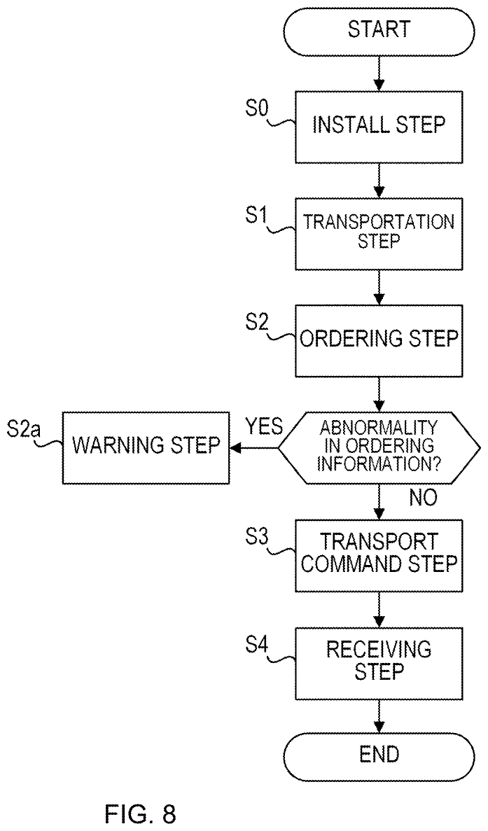

Specifically, in the present embodiment, as illustrated in FIG. 8, the article processing method includes processing of the following steps S1 to S4. In the transportation step S1 after the install step S0, an initial transport command is issued. This initial transport command includes transporting, to the first storage 1, the first type articles corresponding to the first use frequency and directly supplied to the user. Specifically, the calculation device that performs the article processing method, that is, the server 4 of the present embodiment transmits the initial transport command to the transport service provider or the manufacturer of the first type article. Then, an initial quantity of the first type articles is stored in the first storage 1 so as to be taken out by the user.

In the ordering step S2, ordering information is received. Specifically, in the ordering step S2 of the present embodiment, the server 4 receives the ordering information from the ordering device 5 or the terminal device of the user. This ordering information may include different types of articles.

The transport command step S3 selectively issues a transport command in accordance with the ordering information received in the ordering step S2. The transport command includes a first transport command and a second transport command. The first transport command includes an instruction for transportation of the second type article corresponding to the second use frequency lower than the first use frequency from the second storage 2 different from the first storage 1 to a user who uses the first storage 1. The second transport command includes an instruction for transportation of the third type article corresponding to the third use frequency lower than the second use frequency from the third storage 3 different from the first storage 1 and the second storage 2 to a user who uses the first storage 1.

Specifically, the ordering information received from the ordering device 5 in the ordering step S2 includes at least the type and quantity of the articles. In the memory 4a of the server 4, type databases of different types of articles including the first type article database DB1, the second type article database DB2, and the third type article database DB3 are recorded. The first type article database DB1, the second type article database DB2, and the third type article database DB3 include a list of the first type articles, a list of the second type articles, and the third type article, respectively, corresponding to a user.

The list may be different for each user and can be stored individually. By the method of searching the list based on the type of article, it is possible to determine which type article the type of article corresponds to, that is, specifically, to determine whether the article is the first type article, the second type article, or the third type article. Based on the determination of the type of the article, it can be specifically determined which storage or seller will transport the article of that type.

For example, if the determined article type belongs to the first type article, a corresponding transport command may be generated and the generated transport command may be transmitted to a manufacturer or a seller of the first type article or a transport service provider selected by the manufacturer or a seller. When the determined type of the article belongs to the second type article, generation of the first transport command can be selected. The first transport command is for supplying the second type article in the user order from the second storage 2 to the user who uses the first storage 1. The generated first transport command is transmitted to the second storage 2 or displayed in a task list of the transport personnel of the second storage 2. When the determined type of the article belongs to the third type article, generation of the second transport command can be selected. The second transport command is for supplying the third type article in the user order from the third storage 3 to the user who uses the first storage 1. The generated second transport command is transmitted to the third storage 3 or displayed in a task list of the transport personnel of the third storage 3.

According to the above-described method, articles are classified according to the use frequencies of the articles, and the articles are stored in different storages. Then, the classification of the articles is recorded in the server 4 or another information terminal (such as a computer terminal) in order to generate an initial transport command via preset user demand information or temporarily acquired user demand information. Then, direct distribution of the first type articles which can be directly supplied to the user is performed at the first storage 1 based on the initial transport command so that the user can quickly and conveniently obtain the articles that are used more frequently. For example, if the user is a manufacturer owning a factory, the first type articles such as gloves or tapes are the most frequently used articles. After the first storage 1 distributes articles based on the initial transport command, a large number of articles such as gloves or tapes can be arranged in advance, and can be continuously used without reordering, during production in the factory. Therefore, work convenience is improved.

By installing the second storage 2 and/or the third storage 3 and storing the second type articles and the third type articles, appropriate transportation to a user who uses the first storage 1 according to the order demand is possible. As a result, articles with a high use frequency are quickly transported, a transportation speed of the second type articles with a medium frequency is improved, and accumulation of stock of the third type articles with the low use frequency is reduced. For example, in a case where the user is a manufacturer having a factory, hand tools are used less frequently than consumables with the high frequency such as gloves, and the consumption time thereof is relatively long. Therefore, if it is possible to order when necessary, the storage space is not excessively occupied. Note that the use frequency here includes the meaning of being consumed by use, and the use frequency can be equated with the consumption frequency to some extent.

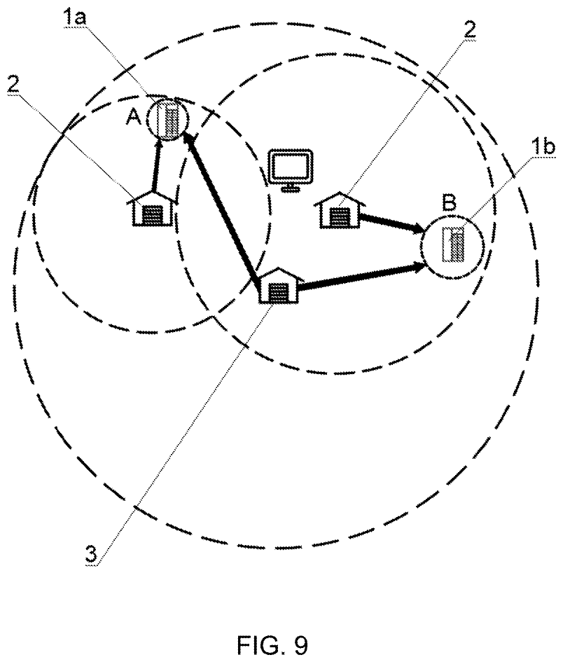

Hereinafter, a specific description will be given with reference to FIG. 9. FIG. 9 is a schematic diagram of transportation paths from a plurality of storages to one user. As illustrated in FIG. 9, the cover ranges of the first, second, and third storages are different. Among these storages, first storages 1a and 1b are used for storage of articles with the high use frequency to be directly supplied to a user A via the first storage 1a or directly supplied to a user B via the first storage 1b based on an initial transport command by the server 4 or the computer device. In addition, the second storage 2 and/or the third storage are used for storing articles with the medium use frequency and/or the low use frequency. Then, the articles are supplied to a plurality of users in a wide range, by utilizing warehouse transportation of articles with the high use frequency in a small range around the users. By using this, the supply range of the articles with the low frequency to the articles with the medium frequency is expanded, and the storage cost can be reduced.

In the present embodiment, as illustrated in FIG. 8, the entire flow of the preferable article processing method further includes the install step S0 of giving an install instruction for selecting and installing a corresponding first storage 1 according to the size of the first type articles. Depending on the size of the articles, the structure of the first storage 1 is adapted to match the size. This increases the adaptability of the first storage 1 to different articles so as to meet storage demands for different first type articles under various circumstances. In particular, the inclusion of the install step in the entirety of the article processing method allows the article provider to install a storage, and a company as a user can avoid an unnecessary increase in cost due to install of the storage.

For small industrial tool articles which are frequently used (first type articles), drawable, rotary, or retractable storage is generally adopted. Among them, a retractable storage is more suitable for storing articles having a large volume requiring a large storage space, but the storage quantity is limited. A rotary storage can store a large quantity of articles, but is susceptible to damage to the articles during the transfer process of the articles. A drawable storage is used to store an appropriate quantity of articles that do not need to be moved.

In a case where articles with the high use frequency in an order placed by the user A are such as a plurality of gloves and dust-free cloth that have a large volume, a retractable storage is adopted as the first storage 1 that covers the demand of the user A so that articles having a large volume are stored more conveniently. In addition, in a case where articles with the high use frequency in an order placed by the user B are such as cutting tools or hand tools that are small and easily damaged, a drawable storage capable of storing more articles, using a space more effectively, and protecting articles from breakage is adopted as the corresponding first storage 1.

After the first storage 1 is installed, the transportation step S1 is performed. Then, the first type article corresponding to the first use frequency is transported to a user who uses the first storage 1. The transportation step S1 can be performed by a manufacturer or a seller of the first type articles or a transport service provider. Alternatively, the transportation step S1 can be performed by the operator of the physical distribution system 100, and there is no limitation on who performs the step. The first type articles of each order can be transported individually and can also be sent out together with articles of another order to save transportation costs.

Thereafter, the processing proceeds to the ordering step S2, and ordering information is received. Specifically, the server 4 receives the collected ordering information from the ordering device 5. The ordering information is collected and analyzed by the ordering device 5 included in the first storage 1 or the ordering device 5 installed near the first storage 1. The ordering information includes information about a type of articles needed by the user, that is, information about which use frequency the needed article has. After the information of the article, the ordering device 5 confirms the identity information and the authentication information of the user, and acquires ordering information of the first level of the user and examination information of the second level.

The ordering information of the first level referred here is preferably ordering information generated by a person who actually performs the ordering operation. Further, the examination information of the second level is preferably examination information generated by examining the ordering information by another person having an examination authority. A specific method of transmitting the ordering information to another person having the examination authority is not particularly limited. For example, mail reminder or reminder method in a software system may be used for examination by the other person. Feedback information after the examination by the other person is transmitted to the ordering device 5 so that the processing proceeds to the next step. Naturally, the examination information of the second level may include information indicating agreement or disagreement. When receiving disagreement information, the ordering device 5 returns to the original interface without proceeding to the next step.

In the ordering step S2, the source of the ordering information is made clearer, and, by installing the ordering device 5, communication between the human and the machine is made more convenient. In addition, the type of the requested article is determined, and the result is reflected in the ordering information. Then, the transport operation provided in the subsequent transport command step S3 can be made more convenient and accurate. In addition, the ordering information of the user, and the examination information obtained after performing collation of the personal authority information of the user and performing the examination are reflected in the ordering information linking the user and the articles. Accordingly, collection and management of statistics and management of storage information can be made easier. Since article information in the ordering information is more abundant, the difficulty of searching for the needed article in the transport command step S3 is reduced, and erroneous transportation is avoided.

Further, the location of the ordering device 5 is not limited here. The ordering device 5 can be built in the first storage 1, and the space can be saved by installing the ordering device 5 integrally with the first storage 1. In addition, a person skilled in the art can understand that the ordering device 5 can be installed as an independent device provided at the first storage 1. The install of the independent device can form a wider space so that more functions can be implemented, and the user experience is further optimized.

For example, the ordering device 5 may be the authentication device 11 that is included in the first storage 1 or is installed near the first storage 1. It can order articles using a variety of methods, for example a camera installed on top part of the authentication device 11 is used. The camera scans an article, and automatically reads the needed article based on scan information to generate image information. When the user places an order, the user clicks the parameter of the article information displayed based on the reading to confirm the order, thereby productivity is greatly improved.

After the ordering information is generated, it is determined whether the ordering information is abnormal according to the ordering information of the first level and the examination information of the second level in the ordering information generated in the ordering step S2. Then, in the case of abnormality, the processing proceeds to the warning step S2a so that warning information is included in the ordering information, and the order exclusion information is transmitted to the user.

Among them, the warning information includes any of abnormality of the identification information, abnormality of the ordering information of the first level, abnormality of the examination information of the second level, or a combination thereof. Specifically, the warning information includes information indicating such as a situation in which the user ID and the ordering information do not match, a situation in which the user does not have an authority to use the storage, a situation in which the user does not have an authority to order the ordered article, and a situation in which the quantity of the ordered articles exceeds the maximum storage quantity of the first storage 1, but is not limited thereto. In addition, it may be a combination of a plurality of situations.

A person skilled in the art will appreciate that another abnormality of the identification information, another abnormality of the ordering information of the first level, and another abnormality of the examination information of the second level are similarly applicable to the present invention. For example, information indicating another abnormality indicates a situation in which the order quantity by the user exceeds a threshold set for the user authority.

In the present embodiment, by providing the warning step S2a, a circular chain including order acquisition, examination, warning, and feedback to the user is established so that the warehouse management forms a complete closed loop. This is advantageous for enhancing warehouse management and improving transport accuracy. Furthermore, a warning is issued for abnormal items in the user identification information, the ordering information by the user, and the examination information of the second level so as to avoid a situation in which an unintended user uses an article without permission or a situation in which the quantity of articles used by the user exceeds the authority. Furthermore, it is possible to enhance the management of the quantity of articles in the storage and the usage state of the user.

When it is determined, after the ordering information is generated, that the ordering information is normal information, the transport command step S3 is subsequently performed. Then, a transport command is issued according to the ordering information received in the ordering step S2. The transport command includes a transport instruction for the second type article and/or the third type article different from the first type article. Then, the article is transported from the second storage 2 and/or the third storage 3 to the location of the first storage 1. Of course, the transport command may include a transport instruction for the first type article.

After the article is transported from the second storage 2 and/or the third storage 3, the receiving step S4 is performed, article sending out information is received, and the article data is updated. Specifically, statistics and updates are performed on the total of the stored articles in the first storage 1 in a timely manner, and receipt information is fed back.

By providing the receiving step S4, timely feedback of the replenishment state of the first storage 1 and timely update of the article information is easier. As a result, reliability of the replenishment process is improved, erroneous transportation is avoided, and the article information can be updated in a timely manner, so that control and management of the storage quantity can be enhanced. More specifically, the update of the article information includes collation with the ordering information. Then, in a case where it is found that there is a difference between the updated new article information and the ordering information, the difference is presented to the user or the article supplier.

Preferably, the time difference between the transport command step S3 and the receiving step S4 is changed according to the transport command. That is, the time for transporting an article to a user who uses the first storage 1 from a different storage (the second storage 2 or the third storage 3) is made different. Specifically, the time difference between the transport command step S3 and the receiving step S4 is from the transport command issued in the transport command step S3 to the delivery information of the received article issued in the receiving step S4. Factors that have a decisive effect on the time difference are the distance between the second storage 2 or the third storage 3 and the location of the first storage 1, and the transportation method. The transport command can also be adjusted by adding other factors such as weather information to the calculation function as parameters.

Specifically, when the transport command issued in the transport command step S3 indicates transportation of an article from the second storage 2 to the location of the first storage 1, the time difference between the transport command step S3 and the receiving step S4 is 4 hours or less. When the transport command issued in the transport command step S3 indicates transportation of an article from the third storage 3 to the location of the first storage 1, the time difference between the transport command step S3 and the receiving step S4 is 24 hours or less. The setting of the time difference is a preferable technique, the time taken for an article to arrive at the user with the second storage 2 used for transportation is 4 hours or less from the ordering. This realizes a “four-hour cover” and greatly improves the user experience.

A specific method for achieving 4 hours or less is not particularly limited, but values based on parameters such as a distance, a transportation method, and weather information can be input to a function, and based on the calculation result of the function, information in the transportation command such as the transportation method and the article sending-out time can be adjusted. In the present embodiment, different transport commands are used to limit the time for transporting articles of different use frequencies from different storages to the user who uses the first storage 1. This also limits, to some extent, the range of user demand covered by the third storage 3 and the second storage 2 and ensures transportation time and supply efficiency.

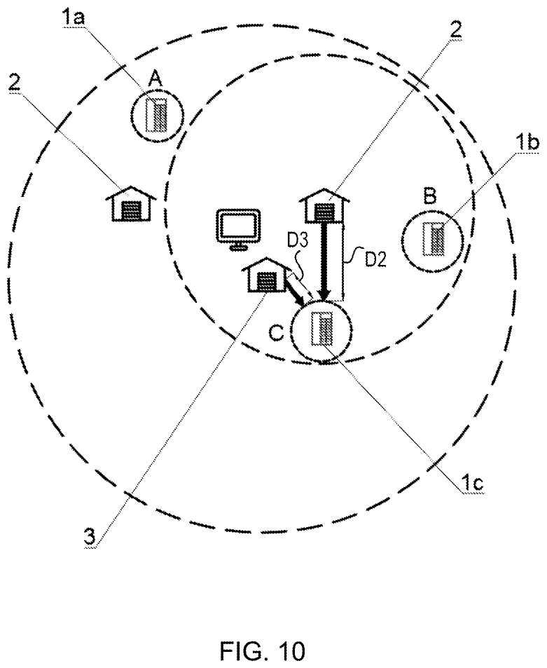

In the present embodiment, the longest transportation time from the second storage 2 to the place where the first storage 1 is installed and the longest transportation time from the third storage 3 to the place where the first storage 1 is installed are limited. However, the absolute distance between the storages is not limited. In FIG. 10, when an article is supplied to a user C, a transport distance D3 from the third storage 3 to the place where the first storage 1 is installed is shorter than a transport distance D2 from the second storage 2 to the place where the first storage 1 is installed. Similarly, the transportation time from the third storage 3 to the place where the first storage 1 is installed is shorter than the transportation time from the second storage 2 to the place where the first storage 1 is installed. Alternatively, the transportation distance from the third storage 3 to the place where the first storage 1 is installed may be the same as the transportation distance from the second storage 2 to the place where the first storage 1 is installed.

A person skilled in the art will appreciate the followings. That is, the transportation time of the third type article from the third storage 3 to a user who uses the first storage 1 is longer than the transportation time of the second type article from the second storage 2 to the user who uses the first storage 1. For example, as long as the transportation time from the second storage 2 to the place where the first storage 1 is installed is 4 hours or less and the transportation time from the third storage 3 to the place where the first storage 1 is installed is 24 hours or less, any relationship with other transportation times does not depart from the protection scope of the present invention. In the present embodiment, the ordering information is received and the transport command is transmitted in the ordering step S2. As a result, if any subsequent ordering information associated with the first storage 1 is not received within a certain period of time after the ordering information is received, the transport command is issued.

In the present embodiment, in the transport command step S3, the condition under which the transport command is issued after the ordering information is received is limited to that any subsequent ordering information is not received within a certain period of time. As a result, it is possible to avoid a situation in which the ordering information is received and the next order requesting the second transportation is received within a short time thereafter, causing transportation by a transportation command issued immediately after another transportation command. Note that the subsequent ordering information here includes ordering information of the same article as the article ordered immediately before and ordering information having the same transport destination (for example, the location of the first storage 1) although the article is different. Therefore, even though they are ordered under separate condition, they can be transported together.

As a modification, an article that is needed and associated with the ordering information may be added to the purchase list. When the amount of money of the articles corresponding to the purchase list is larger than a preset amount of money threshold, a transport command is issued. In this modification, orders when a certain amount of money is reached are collected and articles are centrally supplied on the premise of a preset amount of money. As a result, the supply efficiency can be efficiently improved. Preferably, in the transport command step S3, the transport command further includes a third transport command. The third transport command includes a list of the first type articles to be transported to the first storage 1 or the first type articles to be transported to the user.

In the present embodiment, when the first type article is insufficient in the first storage 1, the article can be transported to a user who uses the first storage 1 in a timely manner. In this way, even if a master agreement is concluded with the user in advance, the first type article can be stored in another storage as part of the contract. Then, when the first type article is occasionally consumed, the article stored in another storage can be quickly and flexibly transported.

More preferably, the transport command step S3 includes a prediction step stated below. In this prediction step, it is determined, based at least on the current transaction record of the first storage 1 or the current log information of the user corresponding to the first storage 1, which article will belong to the first type articles within a certain period of time thereafter.

As an example, the processor 4b functioning as classification means performs the prediction step.

In the present embodiment, the current transaction record of the first storage 1 can effectively reflect the user's past transaction habit. Then, the current log information of the user corresponding to the first storage 1 can effectively reflect the type of article that will be needed by the user in the future. This method can more accurately predict the first type article of a high use frequently. As a result, the type of the article of the first type article can be more accurately predicted, and an article of a type that more satisfies the actual demand of the user can be stored in the first storage 1.

More preferably, the prediction step includes a modeling step and a model applying step. The modeling step provides a project model of the user having different stages and a prediction model. Each stage of the project model has its own type of article belonging to the first type article. In the model applying step, the prediction model is applied to the current transaction record or the current log information to determine a current project stage and a time limit of the project stage. In the transport command step S3, the third transport command is issued when the current time exceeds the time limit of the current project stage. Then, the first type article in the third transport command is determined based on the type of article belonging to the first type article in the next project stage.

In the present embodiment, in the article processing method, a project in progress by the user and a current project stage are predicted. Then, when entering the next project stage, the type of article in the first storage 1 is updated in a timely manner. This can meet the user's actual demand that changes continuously according to the ongoing project. Note that the present embodiment specifically discloses a method of predicting a design item of mechanical equipment, preferably using machine learning. However, it can be understood by those skilled in the art that the present invention is not limited thereto, and methods of predicting the use frequency of the article in other ways are similarly applied to the present invention.

In the generation of a prediction model using machine learning, data collected in at least one of the first storages 1, the second storages 2, and the third storage 3 may be used. For example, in each first storage 1, the use frequency of each article by the user is collected as data, transmitted to the server 4, and used for generation of a prediction model. In addition, a storable quantity of articles may be classified as the first type article in descending order of use frequency in each first storage 1, and the classification data may be transmitted to the server 4. These data pieces are different between the first storages 1.

In addition, the use frequency of each article is collected as data for the plurality of first storages 1 in the region covered by the second storage 2, and is transmitted to the server 4 to be used for generation of the prediction model. In addition, the usage quantities in the plurality of first storages 1 may be summed up, an article with the medium use frequency may be classified as the second type article, and the classification data may be transmitted to the server 4. In this case, an article that is used at a high frequency in some of the first storages 1 but is used at a low frequency in the other first storages 1 may be classified as the second type article. These data pieces are different between the second storages 2.

In addition, the use frequency of each article is collected as data for the plurality of first storages 1 in the regions covered by the second storages 2 in the region covered by the third storage 3, and is transmitted to the server 4 to be used for generation of the prediction model. In addition, the usage quantities in the plurality of first storages 1 may be summed up, an article with the low use frequency may be classified as the third type article, and the classification data may be transmitted to the server 4. In this case, an article that is transported to the first storage 1 at a high frequency in some of the second storages 2 but is transported to the first storage 1 at a low frequency in the other second storages 2 may be classified as the third type article. These data pieces are different between the third storages 3.

Preferably, the transport command step S3 also includes a prediction step stated below. In this prediction step, based at least on the current transaction records of the first storages 1, the distributed quantities in different storages within a certain period of time thereafter are calculated for each first type article. In the present embodiment, the current transaction records of the first storages 1 can effectively reflect the user's past transaction habit. If the current transaction record reflects that the actual consumption quantities of some of the first type articles are relatively large and deviates from the expected consumption quantities, then the allocation quantity to different storages can be adjusted quickly and in a timely manner, with consideration of the distribution speed and the storage space utilization ratio.

Hereinafter, the prediction steps in the present invention will be described in detail regarding to a specific application scenario.

### Application Scenario 1

In the present application scenario, the ordering information by a user is “Order 50 pairs of gloves and 60 tapes”. However, in the user's current transaction record, the user ordered 50 pairs of “gloves” and 60 “tapes” last quarter, but used only 50 “gloves” and 20 “tapes”. Based on the data, in the prediction step, the appropriate storage quantities, that are, distributed quantities of the “gloves” and “tapes” in different storages in a certain period of time (for example, a quarter) may be calculated.

For example, it can be predicted that the usage quantity of articles of the type “glove” will be higher at the next stage. Therefore, more “gloves” can be sent to the first storage 1 as the first type article.

Furthermore, the quantity of “tapes” in the first storage 1 can be adjusted, and the quantity of tapes corresponding to “tapes” part in the ordering information can be stored in the second storage 2 or the third storage 3 and the tapes can be transported as necessary.

### Application Scenario 2

In the present application scenario, the ordering information of the user is “Order 40 gas masks”. However, in the current transaction record of the user, the user also orders articles of the type “filter element” in response to the order of the articles of the type “gas mask”. Therefore, if it is determined that articles of the type “gas mask” is the first type articles in the next project stage of the user, upon entering the next project stage, it is determined that the “filter element”, which is a related article of the “gas mask”, is also the first type article, and the two types of related articles are transported as a set to the first storage 1.

### Application Scenario 3

A design department starts a design work after the demand for mechanical equipment becomes clear. First, the design department designs an overall plan and a main structure, and needs to repeatedly revise and optimize them until requirements such as structure review, cost review, and appearance review are satisfied. Thereafter, the design department designs the entire structure, the detailed structure, and the auxiliary structure to realize the basic functions of the mechanical equipment, and passes the functional evaluation. Subsequently, the design department proceeds test production of the mechanical equipment, performs productivity evaluation and product quality evaluation on the production process and function realization of the prototype equipment, and ends design inspection to realize mass production. In the present application scenario, by constructing a data model corresponding to each design item and comparing user information with the constructed data models to obtain a current design stage of the user, use frequency information of articles of the user after that can be predicted.

For example, in the present embodiment, the modeling step is first performed to provide a project model of the user having different stages and a prediction model. Each stage of the project model has its own type of article belonging to the first type article. Specifically, in the modeling step, the models may be an existing production project model and a prediction model, or may be a project model and a prediction model constructed based on a machine learning method according to user information.

Among these methods, the method of modeling based on machine learning can be more accurately adapted to the actual production situation of the user. Specifically, in this application scenario, a modeling step is performed to collect information about the mechanical equipment design project in actual production. Then, the process of the mechanical equipment design project is divided into a pre-design stage, an intermediate stage, and a late stage. Specifically, different pieces of specific article information of mechanical equipment can be obtained by pieces of project information disclosed by different users. Naturally, a person skilled in the art can understand that other methods capable of acquiring the article information of the mechanical device are similarly applicable to the present invention.

Thereafter, a feature analysis step is performed. Due to certain uncertainty in the development period of time of non-standard mechanical equipment, the relevant process is divided on a daily basis. Specifically, dates in the early stage of design, dates in the middle stage of design, and dates in the late stage of design are correspondingly marked with labels. In addition, before the start of design, the number of days obtained by dividing the total number of days of the design cycle into three is selected and labeled as dates of no design. Then, after a label corresponding to a certain date is determined, the characterization work is performed respectively using the user data, the log data, and the order data at the current date and slightly before the current date.

In some embodiments of the present invention, a storage replenishment method is provided. This replenishment method is applied to a replenishment process of the first storage 1, the second storage 2, and the third storage 3. The replenishment method includes the following steps. That is, the future article consumption quantity is predicted by applying the prediction model to the article information including the storage information, the user information, and the consumption progress. Then, the replenishment information is determined based on the future consumption quantity of the articles and the stock quantity of the articles.

Among them, the information of the storage may include such as the storage number, size, capacity, and usage information of the storage. Furthermore, the user information can be one or a plurality of the information source, the work range, floor, the number of people on the floor, the number of floors of the building, the floor area, and the work cycle of the user. The article information may be basic information of the article, and may be for example, the name, the type, the model number, the price, and other information of the article, or may be multi-stage classification information of a type to which the article belongs, or may be main body data of the article to which the article belongs.

The article information includes consumption/sales information of the article. Then, the consumption/sales information includes the corresponding consumption quantity/sales quantity of the article at different times, and is, for example, the consumption quantity/sales quantity of the article recorded such as daily or weekly, and is data that dynamically changes with time. The replenishment information may include, but is not limited to, the replenishment frequency, the temporary order frequency, the replenishment time, the on-shelf time, the replenishment quantity, and other information.

In some embodiments, the prediction model can be established and trained by the following method. That is, the feature matrix is constructed based on one or a plurality of the article information including the storage information, the user information, and the consumption history, and the stock quantity of the articles. This feature matrix is a feature matrix that reflects the quantities of each article on the time series. The prediction model is then trained based on the feature matrix and the static features of each article that do not change with time to obtain the prediction model.

Examples of the model training algorithm include, but are not limited to, long short-term memory network, LightGBM algorithm, and XgBoost algorithm. In some embodiments, for error calculation, the future consumption quantity may be compared with the actual consumption quantity. For the error calculation, a custom metric based on root mean square error or root mean square error can be used. The custom metric reflects asymmetric risk in sales prediction. The asymmetric risk means that the risk when the prediction data is smaller than the actual data is higher than the risk when the prediction data is larger than the actual data.

By constructing the custom index as described above, it is possible to further reduce the occurrence of article shortage in stock, secure the safety of the stock, and improve the user experience. In some embodiments, in order to provide a future consumption quantity of the week to be predicted, for example, the average, the maximum value, or the minimum value within a historical period of time before the period of time to be predicted may be calculated and used as the consumption quantity/sales quantity information of the article. It may be based on, for example, consumption quantity/sales quantity within n weeks before the week to be predicted, an average of consumption quantity/sales quantities for n weeks before the week to be predicted, whether a consumption record was generated within the n weeks before the week to be predicted, and the fact that a consumption record was generated within the n weeks before the week to be predicted. The average value or the number of consumption times within the n weeks before the week to be predicted is used to give a predicted quantity of future consumption of the week to be predicted.

Thereafter, in the present application scenario, it is preferable to train the prediction model using Light Gradient Boosting Machine (LightGBM) algorithm. The LightGBM is a distributed gradient enhancement framework based on a decision tree algorithm, and can be used for machine learning tasks such as classification and regression. Then, it is possible to increase the training speed of the prediction model without impairing the accuracy, and at the same time, it is very advantageous even in a case where the features are sparse.

Furthermore, a prediction model is trained and selected using a method combining simple cross validation and K-fold cross validation. Specifically, data set is divided into training data and test data at a certain ratio, a model is trained and verified using the training data, and the learning method is finally evaluated using the test data. Furthermore, the training data is randomly divided into several sub-data sets of the same size that do not cross each other, and some of the sub-data sets are used to train the model, and the other sub-data sets are used to validate the model. Then, after repeating the processing a plurality of times, a model with the highest accuracy is selected among the models, or the models are combined to obtain a final prediction model.

Next, the model applying step is performed to apply the prediction model obtained in the modeling step described above to the current transaction record or the current log information. Then, the current project stage of the user and the time limit of the current project stage are determined based on the current user information. If the time limit of the current project stage has been exceeded, that is, if the current project stage has been ended and the next project stage has been entered, a third transport command is issued in the transport command step S3. Then, the first type article in the next project stage based on the prediction model is transported to the user who uses the first storage 1, or a list of the first type article is provided to the user.

For example, according to the project model generated in the modeling step, the user's project is divided into three stages of an early stage, an intermediate stage, and a late stage according to the progress time of the project. It is assumed here that the first type articles corresponding to the three stages are “gloves”, “mask”, and “tape”, respectively. In this case, the current transaction record and the current project information of the user are obtained from the log information, and the current project information is compared with the project model to obtain that the user is currently in the middle stage of the project. That is, the current first type article is the “mask”. Here, during the middle stage, the “mask” is transported to the first storage 1. If, as a result of the comparison, it is obtained that the user is in the late stage and not in the middle stage, the first type article is adjusted to the “tape” and the “tape” is transported to the first storage 1 in order to provide timely transport according to the user's actual needs.

### [Stock Trial Calculation Method]

In order to ensure that the service level of the user is not affected between two transports, the quantity of articles stored in the first storage 1 may also be calculated according to the actual capacity or storable quantity of the first storage 1. As an example, a theoretical storage quantity is calculated based on the user's actual use performance, the transportation cycle, and the coefficient of variation of a product (coefficient of variation). For example, the calculation includes, but is not limited to, aspects described below.

In a first aspect, information related to the first storage 1, such as the storage space of the first storage 1 and the maximum storage capacity of a single section is acquired. In addition, a user obtaining record within a past certain period of time is acquired. The user obtaining record includes, but is not limited to, the number of users who receive the articles, the frequency of receipt, the number of times of receipt, and information specifying a person in charge of receipt, for example. However, these pieces of information are main information. When the acquisition of the information is completed, auxiliary information such as a distance between the plurality of first storages 1 and a special condition of each user is acquired.

Then, when the acquisition of the information is completed, the logical calculation for the first level is performed, and the calculation result is recorded. Specifically, the average weekly request quantity, the weekly maximum request quantity, the weekly standard deviation (standard deviation), the coefficient of variation (coefficient of variation), and other related information of the user are calculated according to the request data of the user, and the safety factor of each article is set. Furthermore, in combination with the current transportation frequency, the storage quantity of each article of the first level is calculated. Then, the calculation result is recorded.

Subsequently, the calculation result is compared with the space of the first storage 1. If the space is filled with the calculated quantity of articles, the trial calculation logic is used to set the storage quantity of the first storage 1 according to the calculation result. On the other hand, if the space is not filled with the calculated quantity of articles, a follow-up response is performed.

In a second aspect, if the first storage 1 has insufficient space, a plurality of quantities is used. That is, a new minimum quantity is added based on the existing minimum quantity to match the calculation result. In the following description, an additional minimum quantity is described, but it is not limited to the additional minimum quantity.

Detailed information such as an order time point and an ordering person is allocated to an order quantity of the user for each order using order data (or purchase request data) by the user and recorded as a unit order quantity. According to the certain period of time, the mode with the highest frequency among the unit order quantities is the newly added minimum quantity. Further, when matching the current minimum quantity, the second mode is selected. Then, the adopted new and additional minimum quantity is recorded. The theoretical additional minimum quantity is compared with the actual maximum quantity that can be arranged in the storage section of the first storage 1. Then, the smaller value is selected as the final additional minimum quantity.

By combining the above, two minimum request quantities corresponding to each article are acquired. Then, two minimum replenishment section numbers are assigned by combining the number of occurrences of the unit request quantity within the current transportation frequency period of time. Specifically, a value of the final additional minimum quantity included in the requesting unit is larger than the newly added minimum request quantity. Then, the number of requests occurring in the transportation frequency period of time is used as the number of sections for the newly added minimum request quantity. Thereafter, the storage quantity is predicted according to the trial calculation logic described above, and the storage quantity, which is the calculation result, is assigned to the section numbers.

After being assigned to the section numbers, the storage quantity is compared with the space of the first storage 1. Then, in the case where the space is filled with the articles, the storage quantity, which is the calculation result, the two minimum request quantities, and the corresponding section numbers are used. On the other hand, if the space is not filled, further adjustment is performed.

In a third aspect, the safety factor is adjusted again according to the coefficient of variation of the article, if the minimum quantity is not satisfied even by the above-described aspect, but it is not limited to this way.

Specifically, the safety factor is set based on fixation of two minimum request quantities. When the coefficient of variation is large, the safety factor is large, and when the coefficient of variation is small, the safety factor is small. Assuming that the space of the first storage 1 is filled, the maximum stock is targeted, and the overall safety factor is adjusted up and down until the maximum stock is reached. At this point, the stock of each article is determined. This adjustment is recorded as a second level adjustment result.

In summary, the overall storage stock calculation includes, but is not limited to, the above solutions. All the aspects are linked, and it can be achieved by one aspect or a combination of two aspects. The object is always to improve the user's usage efficiency and to improve the level of customer service. At the same time, the frequency of transportation can be reduced.

In each of the above-described embodiments of the present specification, each of the numbers S1 to S4 is assigned to each step, but these numbers are for convenience of description and do not limit the order of performing the steps. In the present embodiment, the memory 4a is a computer-readable non-transitory storage medium, and can include a non-volatile memory such as a read only memory (ROM), a programmable read only memory (PROM), an erasable programmable read only memory (EPROM), a flash memory, or any other device capable of storing a program command or data when power is applied or is not applied.

In addition, the memory 4a can include a volatile memory such as a random access memory (RAM), a static random access memory (SRAM), a dynamic random access memory (DRAM), and a synchronous dynamic random access memory (SDRAM). Furthermore, the memory 4a may be implemented using another type of RAM.

The memory 4a may be implemented using a single memory module or a plurality of memory modules. Note that although the memory 4a is illustrated as a part of a computing device, those skilled in the art will recognize that the memory 4a can be separated from the computing device without departing from the scope of the present invention.

The processor 4b is a general-purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, a gate logic, a discrete hardware component, any other arbitrary processing unit, or a combination of one or a plurality of these processors.

A computer device may also be a general computing system, an embedded controller, a portable computing device, a server, a mobile device, a smartphone, an onboard information system, one or more processors associated with a monitor, a custom machine, other hardware platform, or a combination of these computing devices. Furthermore, the computer device may be configured as a distributed system formed by a plurality of computing devices interconnected via network data or a bus system.

In the plurality of embodiments described above, the description of each embodiment focuses on a respective feature, and for parts that are not described in detail in the embodiment, related descriptions of other embodiments may be referred. The technical solutions of different embodiments may also be combined with each other. This solution obtained by such combination still belongs to the protection scope of the present invention. Further, the present invention is not limited to the above-described embodiments. Inventions modified within a range not contrary to the present invention and inventions equivalent to the present invention are also included in the present invention.

Some or all of the above embodiments may also be described as follows, but are not limited to the following description.

An article processing method includes: a transportation step of issuing an initial transport command for transporting a first type article corresponding to a first use frequency to a first storage capable of directly supplying the first type article to a user; an ordering step of receiving ordering information; and a transport command step of receiving the ordering information through the ordering step and selectively issuing a transport command, the transport command includes a first transport command and a second transport command, the first transport command includes a transport instruction for transporting a second type article corresponding to a second use frequency lower than the first use frequency from a second storage different from the first storage to the first storage, and the second transport command includes a transport instruction for transporting a third type article corresponding to a third use frequency lower than the second use frequency from a third storage different from the first storage and the second storage to the first storage.

A physical distribution system includes: a first storage that stores at least a first type article corresponding to a first use frequency and is capable of directly supplying the first type article to a user; a second storage that stores at least a second type article corresponding to a second use frequency lower than the first use frequency; a third storage that stores at least a third type article corresponding to a third use frequency lower than the second use frequency; an ordering device that receives ordering information of an article; and a transport command unit that selectively issues a transport command in response to receiving the ordering information from the ordering device, the transport command includes a first transport command and a second transport command, the first transport command includes a transport instruction for causing transportation of the second type article from the second storage to the first storage, and the second transport command includes a transport instruction for causing transportation of the third type article from the third storage to the first storage.

As a result, the articles can be classified according to the use frequencies of the articles, and the articles can be stored in various storages. Then, an initial transport command is generated in the server or another information terminal through preset user demand information or temporarily acquired user demand information. In addition, the first type article directly supplied to a user is supplied to a first storage based on the initial transport command. Then, a second and/or third storage for storing the second type article and/or the third type article is installed. Thus, the user can quickly and conveniently receive the first type article that is used more frequently. In addition, articles used high frequently are quickly transported to the first storage according to the order demand. Furthermore, it is possible to increase the transportation speed of the second type article with the middle use frequency and further reduce accumulation of stock of the third type articles with the low use frequency.

Preferably, the distance between the third storage and the first storage is greater than the distance between the second storage and the first storage.

Preferably, the article processing method further includes an install step of issuing an install command for causing selection and install of a corresponding first storage according to the size of the first type article.

As a result, a first storage having a corresponding structure or size is selected and installed depending on the size of the article. Therefore, adaptability of the first storage to different articles can be improved, and storage demands of different first type articles can be satisfied under various situations. In particular, the inclusion of the install process in the entire system enables the article provider to install a storage and the company as a user to avoid unnecessary cost increase due to the install of the storage.

Preferably, in the ordering step of the article processing method of the present invention, the ordering information is, specifically, ordering information from the ordering device built in the first storage or the ordering device installed near the first storage, and the ordering information includes article type information.

As a result, the source of the ordering information in the article processing method of the present invention is made clearer, and by adding the ordering device, interaction between the human and the machine can be made easier. In addition, by determining the type information to which the target article belongs and reflecting the determining result in the ordering information, the work method provided by the subsequent transport command step becomes more convenient and accurate.

Preferably, in the article processing method of the present invention, the ordering information includes the examination information of the second level together with the ordering information of the first level of the user.

According to this configuration, the ordering information of the user and the examination information are reflected in the ordering information, the examination information is associated with the user and the article, and the statistics and management of the storage/replenishment information can be more easily performed. In addition, even in a case where the ordering information by the user is invalid or unnecessary, it can be restricted using the examination function. Then, in a case where the examination information is included, the next transport operation can be started, and inappropriate purchase by the user can be avoided.

Preferably, the ordering information received in the ordering step includes image information of a desired article.

According to this configuration, the image information can make the article information in the ordering information more abundant, so that the search difficulty of the article is reduced, and erroneous transportation can be avoided to some extent. In particular, the article can be scanned by the first storage or by the ordering device installed near the first storage. Thus, the ordering step can be completed by providing the image information of the product directly to the server and subsequently further identifying the product. Therefore, ordering is very convenient and quick, and the user experience is greatly improved.

Preferably, after the ordering step, an alarm step is further included, and the order abnormality information is transmitted to the user in a case where the ordering information includes the alarm information.

Thus, a warning step is added after the ordering step so that a circular chain of order acquisition, examination, warning, and feedback to the user is established. This is advantageous to further enhance warehouse management and increase transport accuracy. In particular, in a case where some of the employees of the user erroneously order a large quantity of articles, the internal investigation can be easier by notifying the user using the warning information to improve the production efficiency.

Preferably, the warning information includes any of the abnormality of the identification information, abnormality of the ordering information of the first level, or abnormality of the examination information of the second level.

Thus, by issuing a warning for an abnormal item of the user identification information, the ordering information of the user, and the examination information of the second level, it is possible to prevent occurrence of a situation in which an external user uses the internal information without permission, or a situation in which a user uses the article beyond the use authority or the use quantity. Therefore, it is possible to further enhance the article take-out management at the storage.

Preferably, the article processing method of the present invention further includes a receiving step of receiving article delivery information and updating article data.

As a result, by adding the receiving step, the replenishment state of the first storage can be fed back in a timely manner, and the article information can be updated in a timely manner. Therefore, reliability of the transportation process can be improved, and control and management of the quantity in the warehouse can be enhanced by timely updating the stock information.

Preferably, the time difference between the transport command step and the receiving step of the article processing method is appropriately changed according to the transport command.

As a result, the time for transporting articles from the different storages to a user who uses the first storage differs according to different transport commands. For example, the time required for transportation from the second storage to the user using the first storage (preferably within 4 hours) varies depending on parameters such as a distance. The transport command can be adjusted based on parameters such as a distance, thereby making different time differences.

Preferably, in the transport command step, the ordering information is received through the ordering step and the transport command is issued, and if any subsequent ordering information associated with the first storage is not received within a certain period of time after the ordering information is received, the transport command is issued.

According to this configuration, the condition of outputting the ordering information in the transport command step from the reception of the ordering information is limited to that any subsequent ordering information is not received within a certain period of time. Therefore, it is possible to avoid a situation in which a transportation command is issued immediately after ordering information is received and transportation is required twice in a short period of time due to a subsequent order.

In the transport command step, the command in response to the ordering information received from the ordering step includes adding a necessary article related to the ordering information to a reservation list. In addition, the command includes issuing a transport command when the amount of money of articles corresponding to the purchase list is equal to or more than a threshold of the preset amount of money. According to this configuration, the amount of money is set in advance, and orders reaching a certain amount of money are collectively and intensively supplied, whereby the supply efficiency can be effectively enhanced.

Preferably, when the transport command issued in the transport command step is for transportation from the second storage to the location of the first storage, the time difference between the transport command step and the transportation step is 4 hours or less, and when the transport command issued in the transport command step is for transportation from the third storage to the location of the first storage, the time difference is 24 hours or less.

As a result, it is possible to limit time for different transport commands, that is, time for transporting items with different use frequencies from different storages to the location of the first storage. Therefore, to some extent, the range of users covered by the third storage and the second storage can be limited to guarantee the transportation time, and at the same time, the transportation efficiency can be improved.

Preferably, in the transport command step, issuing the transport command in response to receiving the ordering information from the ordering step includes calculating information of articles in the ordering information and the related article information according to a predetermined function, and issuing the transport command for simultaneously transporting the articles in the ordering information and the related articles when a predetermined condition is satisfied.

According to this configuration, the supply efficiency can be further improved by predicting the subsequent correlated article loss using data correlation.

Preferably, in the transport command step, the transport command also includes a third transport command, and the third transport command includes a list of the first type articles to be transported or the first type articles to be provided to a user utilizing the first storage.

As a result, when the first type articles in the first storage is insufficient, the first type articles can be transported to the user who uses the first storage. In addition, even if the contract is concluded with the user in advance, some of the first type articles of the contract can be placed in another storage, and can be quickly transported from the other storage.

Preferably, the transport command step includes a prediction step, and in the prediction step, based at least on a current transaction record of the first storage or current log information of the user corresponding to the first storage, which articles will belong to the first type articles within a certain period of time after that time is determined.

As a result, the current transaction record of the first storage can effectively reflect the user's past transaction habit. In addition, the current log information of the user corresponding to the first storage can effectively reflect a transaction type of the user that may occur in the future. Therefore, the first type article with the first use frequency can be accurately predicted. Then, the first type article can be flexibly adjusted, and the actual demand of the user can be satisfied with the type of article stored in the first storage.

Preferably, the prediction step includes a modeling step and a model applying step, in the modeling step, a project model having different stages and a prediction model are provided, each stage of the project model has its own type of article belonging to the first type article, in the model applying step, a third transport command is issued when the time limit of the current project stage has been exceeded, and the first type article in the third transport command is determined based on the first type article of the next project stage.

As a result, in the article processing method, a project of the user and the current project stage of the user are predicted. Then, when entering the next project stage, the type of article in the first storage is updated in a timely manner to satisfy an actual demand that changes continuously according to the user's project.

Preferably, the prediction step includes a modeling step and a model applying step, in the modeling step, a project model having different stages and a prediction model are provided, each stage of the project model has its own type of article belonging to the first type article, in the model applying step, a current project stage and a time limit of the current project stage are determined based on the current transaction record or the current log information.

Preferably, in the transportation step, the update of the article information includes collation of the updated new article information with the ordering information.

Preferably, the transport command step includes a prediction step of calculating distributed quantities of the first type article, the second type article, or the third type article in different storages within a certain period of time using at least a current transaction record of the first storage, the second storage, or the third storage.

As a result, the current transaction record of the first storage can effectively reflect the user's past transaction habit. Then, when in the current transaction record, the actual consumption quantity of some of the first type articles is relatively large, and thus deviates from the expected consumption quantity, it is possible to adjust the allocation quantity to different storages quickly and in a timely manner. Therefore, it is possible to improve the distribution speed and the space utilization ratio of the storage.

Preferably, the first storage is a vending machine installed at or near a place where the user is.

As a result, the user can take out the article by himself/herself, so that the area for installing the storage can be reduced. In addition, it is possible not only to receive the article conveniently and quickly, but also to save labor costs caused by the user arranging the managers of the storages individually.

Preferably, the first storage includes an authentication device and a plurality of storage sections, the user includes a plurality of sub users, the physical distribution system records authorities of the respective sub users, and the first storage opens a door of the corresponding storage cabinet based on the authorities of the sub users recognized by the authentication device.

As a result, the sub users, for example, employees of the company, can order the first type article (for example, regular consumables) at least within his/her authority by himself/herself, and payment for the first type articles can be made collectively by the physical distribution system. Therefore, the flow of ordering and payment can be simplified, and the operation efficiency of the physical distribution system can be improved.

Preferably, the authority corresponds to the type and quantity of the first type articles receivable by the sub user, and the first storage opens the door of the storage section in which the corresponding type and quantity of the first type articles are stored, according to the authority of the sub user recognized by the authentication device.

As a result, each sub user can acquire a reasonable quantity of the first type articles according to a preset rule, and the safety and the reasonability of distribution of the first type articles can be improved.

Preferably, the first storage further includes a stock management module, and the stock management module monitors a stock quantity of the first type articles in the first storage and sends a transport request when the stock quantity is less than a threshold.

As a result, when the stock quantity of the first type articles decreases to the threshold or less, the first type articles are automatically transported. Therefore, the stock quantity of the first type articles can be always maintained at a reasonable level or more, and it can be guaranteed that the supply of the first type articles is sufficient.

As a preferred aspect, the first storage further includes a stock management module that periodically transmits the transportation request based on the ordering information.

As a result, the article can be periodically transported based on the rule determined in advance, and the arrangement of the payment and transportation can be more convenient.

Preferably, the server includes a processor and a memory storing commands that are readable by the processor when performing the article processing method. In addition, a computer readable medium stores a command which, when executed by a processor of a computing device, causes the computing device to perform the article processing method.

### REFERENCE SIGNS LIST

1, 1a, 1b, 1c First storage
10 Storage section
11 Authentication device
12 Unlocking unit
13 Receiving unit
14 Stock management module
2 Second storage
3 Third storage
21 Order receiving unit
31 Order receiving unit
4 Server
41 Transport command unit (transport command means)
4 Server (physical distribution management device)
4a Memory
4b Processor (acquisition unit, classification unit, and update unit)
5 Ordering device
DB Vendor database
DB1 First type article database
DB2 Second type article database
DB3 Third type article database
DB4 User authority database

1-12. (canceled)

13. A physical distribution management device that manages a first storage which stores a first type article, the physical distribution management device comprising:
a user authority database recording an authority which is set for each account of a plurality of sub users based on an account made by a main user who uses the first storage, which is any one of a plurality of different authorities that differ in a type, quantity, or total amount of money of the first type article that can be taken out, and which is recorded in association with each account,
wherein the first storage is an automatic locker or a vending machine which includes a plurality of storage sections,
the first storage is configured to open a corresponding storage section among the plurality of storage sections according to the authority,
the first storage authenticates the sub user who takes out the first type article, and
the first storage opens the storage section corresponding to the authority associated with the authenticated sub user based on the user authority database.

14. The physical distribution management device according to claim 13, wherein the first storage determines the authority associated with the authenticated sub user by referring to the user authority database, and opens the storage section corresponding to the determined authority.

15. The physical distribution management device according to claim 13, wherein the plurality of authorities includes a higher authority and a lower authority,
the first storage opens the storage section which stores a large quantity of or a large number of types of the first type articles among the plurality of storage sections when the authority associated with the authenticated sub user is the higher authority, and
the first storage opens the storage section which stores a small quantity of or a small number of types of the first type articles among the plurality of storage sections when the authority associated with the authenticated sub user is the lower authority.

16. The physical distribution management device according to claim 13, manages a physical distribution system that uses the first storage, a second storage that stores a second type article to be transported to a user who uses each of a plurality of the first storages, and a third storage that stores a third type article to be transported to a user who uses each of the plurality of first storages corresponding to each of a plurality of the second storages,
the physical distribution management device comprising:
an acquisition unit acquiring a use frequency of an article of each user; and
a classification unit classifying the article corresponding to a first use frequency as the first type article, classifying the article corresponding to a second use frequency lower than the first use frequency as the second type article, and classifying the article corresponding to a third use frequency lower than the second use frequency as the third type article, based on the use frequency of each of a plurality of users belonging to a transport target region set for the third storage.

17. A storage that stores a first type article, and that is an automatic locker or a vending machine which includes a plurality of storage sections, wherein
the storage is connected to a user authority database recording an authority which is set for each account of a plurality of sub users based on an account made by a main user who uses the first storage, which is any one of a plurality of different authorities that differ in a type, quantity, or total amount of money of the first type article that can be taken out, and which is recorded in association with each account,
the storage is configured to open a corresponding storage section among the plurality of storage sections according to the authority,
the storage authenticates the sub user who takes out the first type article, and
the storage opens the storage section corresponding to the authority associated with the authenticated sub user based on the user authority database.

18. A controlling method of a physical distribution system that is managed by a physical distribution management device, and that uses a first storage storing a first type article and being an automatic locker or a vending machine which includes a plurality of storage sections, the controlling method comprising:
recording in a user authority database, by the physical distribution management device, an authority which is set for each account of a plurality of sub users based on an account made by a main user who uses the first storage, which is any one of a plurality of different authorities that differ in a type, quantity, or total amount of money of the first type article that can be taken out, and which is recorded in association with each account;
authenticating the sub user who takes out the first type article by the first storage; and
opening the storage section corresponding to the authority associated with the authenticated sub user among the plurality of storage sections based on the user authority database.

19. A control program for a physical distribution system that uses a first storage storing a first type article and being an automatic locker or a vending machine which includes a plurality of storage sections, and that includes a user authority database recording an authority which is set for each account of a plurality of sub users based on an account made by a main user who uses the first storage, which is any one of a plurality of different authorities that differ in a type, quantity, or total amount of money of the first type article that can be taken out, and which is recorded in association with each account,
wherein the first storage is configured to authenticate the sub user who takes out the first type article, and to open a corresponding storage section among the plurality of storage sections according to the authority, and
the control program causing a computer of the physical distribution system:
to open the storage section corresponding to the authority associated with the authenticated sub user based on the user authority database.
